(19) United States
(12) Patent Application Publication
(10) Pub. No.: US 2013/0311204 A1
(43) Pub. Date: Nov. 21, 2013

(54) SYSTEM AND METHOD FOR MONITORING PATIENTS

(71) Applicant: General Electric Company, Schenectady, NY (US)

(72) Inventor: Lokesh SHANBHAG, Bangalore (IN)

(73) Assignee: General Electric Company, Schenectady, NY (US)

(21) Appl. No.: 13/887,658

(22) Filed: May 6, 2013

(30) Foreign Application Priority Data
May 16, 2012 (IN) 1949CHE2012

(51) Int. Cl. G06F 19/00; G06Q 50/24

(52) U.S. Cl. CPC G06F 19/322; G06Q 50/24
USPC 705/3

(57) ABSTRACT

A system and method for monitoring multiple patients. The system includes one or more processors for receiving multiple health parameters associated with each patient and parameter values associated with the health parameters. The processors classify each patient in a clinical category of multiple clinical categories based on the health parameters. Each clinical category indicates a criticality level associated with a health condition of a patient. The processors also present health profiles of the patients based on a clinical category associated with each patient in a user interface for monitoring each patient. The health profiles indicate the parameter values associated with the health parameters. The plurality of clinical categories and the plurality of health parameters are stored in a memory.

### TECHNICAL FIELD

The subject matter disclosed herein relates to monitoring of patients. More specifically relates to a system and method for monitoring patients.

### BACKGROUND OF THE INVENTION

Patient monitoring is a necessity for patients having a serious health condition admitted in hospitals/health care units. Numerous patient monitoring devices are available and these devices monitor different health parameters of a patient. The health parameters may include for example, blood pressure, pulse pressure, body temperature, heart rate, neurological activities, respiratory frequencies, saturated percentage of oxygen in the blood (Sp0₂), carbon dioxide measurement, cardiac output, end-tidal carbon dioxide concentration (EtCO₂) and airway respiratory rate (AWRR). The health parameters are monitored and displayed in a user interface of a patient monitoring system. The health parameters may be displayed in the various forms such as but not limited to tracings along an X-Axis associated with time, and numerical values. Such patient monitoring systems enable a nurse or any medical practitioner to monitor a health condition of a patient.

For example a patient monitoring system may show variation in health parameters associated with multiple patients at same time such as, 16 or 32 patients. The patient monitoring system may have a user interface presenting the health parameters and parameter values associated with these health parameters of 16 or 32 patients. Further these patients and their health parameters may be displayed based on but not limited to their bed numbers and patient identification numbers. Any variation in the health parameters indicates the health condition of each patient. The patient monitoring system may be handled by a nurse or a medical attendant from another location remote from the location where the patient is present. Even though the health condition of many patients can be viewed from one patient monitoring system an emergency situation of a patient is still not recognized in a convenient and quick manner. Explained in another way, these patient monitoring systems display the variations in health parameters such that the nurse or the medical attendant gives equal attention to all patients. A patient in a highly critical condition may have sudden variations in health parameter values that may not be easily detected in order to take emergency action.

Thus there is a need for a system and method for monitoring patients to detect any emergency condition associated with a patient.

### BRIEF DESCRIPTION OF THE INVENTION

The above-mentioned shortcomings, disadvantages and problems are addressed herein which will be understood by reading and understanding the following specification.

As discussed in detail below, embodiments of the invention include a system for monitoring one or more patients. In an embodiment, the system includes at least one processor configured to receive one or more health parameters associated with each patient and one or more parameter values associated with the health parameters. Each processor classifies each patient in a clinical category of a plurality of clinical categories based on the health parameters. Each clinical category indicates a criticality level associated with a health condition of a patient. Each processor also presents health profiles of the patients based on the clinical category associated with each patient in a user interface for monitoring each patient. The health profiles indicate the parameter values associated with the health parameters.

In an embodiment, a method for monitoring one or more patients is disclosed. The method includes receiving one or more health parameters associated with each patient and parameter values associated with the health parameters. Each patient is classified in a clinical category of a plurality of clinical categories based on the health parameters. Each clinical category indicates a criticality level associated with a health condition of a patient. The health profiles for each patient are presented based on the clinical category associated with each patient in a user interface for monitoring. The health profiles indicate the parameter values associated with the health parameters.

Various other features, objects, and advantages of the invention will be made apparent to those skilled in the art from the accompanying drawings and detailed description thereof.

### BRIEF DESCRIPTION OF THE DRAWINGS

FIG. 1 is a schematic illustration of a system for monitoring multiple patients in accordance with an embodiment of the present invention;

FIG. 2 is a schematic illustration of a user interface displaying patients in clinical categories in accordance with an embodiment of the present invention;

FIG. 3 is a schematic illustration of a user interface displaying patients changing from a current clinical category to another clinical category in accordance with an embodiment of the present invention;

FIG. 4 is a schematic illustration of a user interface displaying the patients shifting between multiple clinical categories in accordance with an embodiment of the present invention;

FIG. 5 is a schematic illustration of a user interface element depicting a comparison of a current health condition of a patient with a previous health condition and a desired health condition of the patient in accordance with an embodiment of the present invention;

FIG. 6 is a schematic illustration of a user interface element depicting a variation of health condition of a patient in accordance with an embodiment of the present invention; and

FIG. 7 illustrates a flow diagram of a method for monitoring multiple patients in accordance with an embodiment of the present invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In an embodiment a system for monitoring multiple patients is disclosed. The system includes one or more processors for receiving multiple health parameters associated with each patient and parameter values associated with the health parameters. The processors classify each patient in a clinical category of multiple clinical categories based on the multiple health parameters. Each clinical category indicates a criticality level associated with a health condition of a patient. The processors also present health profiles of the multiple patients based on a clinical category associated with each patient in a user interface for monitoring each patient. The health profiles indicate the parameter values associated with the multiple health parameters.

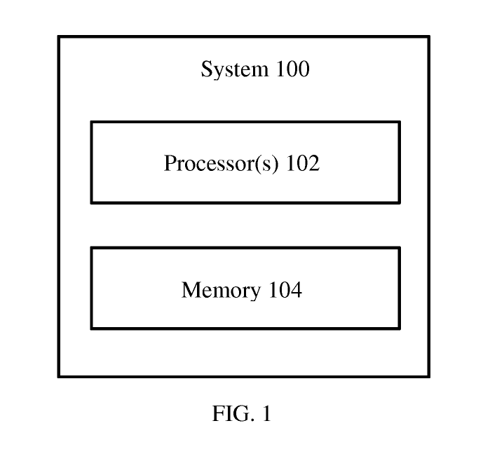

FIG. 1 is a schematic illustration of a system 100 for monitoring multiple patients in accordance with an embodiment. The patients admitted in a hospital may have different health conditions such as but not limited to, critical, serious, good, fair, deceased, stable, progressing well, critical but stable, and discharged. These patients need to be constantly monitored as their health condition can change any time. The system 100 includes one or more processors such as processor(s) 102. The processor(s) 102 receives multiple health parameters associated with each patient and parameter values associated with these health parameters. The multiple health parameters may include but are not limited to blood pressure rate, heart rate, body temperature, respiratory rate, pulse pressure, neurological activities, respiratory frequencies, saturated percentage of oxygen in the blood (SP0₂), carbon dioxide measurement, cardiac output, end-tidal carbon dioxide concentration (EtCO₂) and airway respiratory rate (AWRR), systolic pressure rate, and diastolic pressure rate. The processor(s) 102 also receives one or more parameter values associated with each health parameter. These parameter values and the health parameters are received from various medical devices connected to a patient's body. These medical devices may include but are not limited to, an Echocardiography (ECG) device, a blood pressure monitor and a pulse rate monitoring device. In another embodiment, the health parameters and their parameter values may be received as an input from a nurse or a medical expert. The health parameters and the parameter values may be stored in a memory 104.

In an embodiment, an ECG device connected to the patient's body monitors a health parameter such as heart rate. The heart rate may be expressed in heart beats per minute (bpm) i.e. a parameter value. Parameter values associated with the health rate may be continuously monitored and provided to processor(s) 102 of the system 100. Similarly, various medical devices may be connected to the patient's body to monitor other health parameters and parameter values associated with these health parameters.

The processor(s) 102 then classifies each patient in a clinical category. The patients are classified based on the health parameters to be monitored for each patient. A clinical category may indicate a criticality level associated with a health condition of the patient. Multiple clinical categories may be stored in the memory 104 from which a clinical category may be selected and assigned to each patient. The multiple clinical categories may include but are not limited to critical, serious, fair, good and undetermined. Each clinical category may be associated with a set of health parameters. In an embodiment, each health parameter associated with a clinical category may have a threshold parameter value. The categories differ from each other in terms of health parameters and threshold parameter values associated with the health parameters. For example, a patient classified in a critical category may have more number of health parameters or different health parameters that need to be monitored as compared to other clinical categories. Further, one or more threshold parameter values of the critical category may be higher as compared to one or more threshold parameter values associated to the corresponding health parameters in other clinical categories.

In another example a patient may be classified in an undetermined category when few health parameters and associated parameter values are satisfactory and other health parameters and their parameter values are not satisfactory or not clearly determinable or have frequent fluctuations. In such a situation, a health condition of the patient may likely worsen or improve thus may not be clearly defined. In an embodiment the multiple clinical categories may include clinical categories dependent on treatment or surgical procedure conducted on the patient. For example, a patient who has undergone an ENT surgery may need to be monitored. In this scenario a clinical category including a set of health parameters and threshold parameter values related to ENT may be applied. Thereafter, the patient may be monitored based on the applied clinical category.

In order to determine an appropriate clinical category to be assigned to the patient, the processor(s) 102 may determine whether the set of health parameters associated with each clinical category matches with health parameters that need to be monitored for a patient. Further, a parameter value associated with a health parameter determined by a medical expert may be compared with the threshold parameter value associated with a corresponding health parameter of a clinical category. For example, if the monitored parameter value is above a threshold parameter value then the patient may be classified in a clinical category that is related to the threshold parameter value.

Explaining by way of an example, a patient may undergo a medical analysis under a doctor. The doctor may determine health parameters that need to be monitored and also parameter values associated with the heath parameters based on the analysis. An appropriate clinical category, such as critical, may be identified based on the suggested health parameters and the parameter values. In this case, the critical category may be selected when it is identified that the parameter values are above threshold parameter values applicable to the critical category. The critical category may include various health parameters such as, heart rate, pulse rate, body temperature, respiratory rate, pulse pressure, neurological activities, respiratory frequencies, saturated percentage of oxygen in the blood (SP0₂), carbon dioxide measurement, cardiac output, end-tidal carbon dioxide concentration (EtCO₂) and airway respiratory rate (AWRR), systolic pressure rate, and diastolic pressure rate. The critical category is selected and the associated health parameters are monitored for the patient.

In an embodiment the critical category may be selected manually by the doctor or a nurse. The doctor may suggest the health parameters and the nurse handling the system 100 may select the appropriate clinical category such as the critical category from the multiple clinical categories stored. This selection process may be manual by comparing the suggested health parameters and parameter values with health parameters and threshold parameter values of each clinical category. The critical category is then applied. In another embodiment, the critical category may be automatically selected by the processor(s) 102. The processor(s) 102 selects the critical category based on the health parameters and the parameter values received from one or more of the nurse and the medical devices connected to the patient. In an embodiment the processor(s) 102 may shift the patient to the critical category in response to receiving a confirmation response from the user such as the nurse and the medical expert.

In some instances the multiple clinical categories stored in the memory 104 may not be completely applicable to the patient based on patient's health condition. In such a scenario the processor(s) 102 may alter a clinical category and associated health parameters based on user inputs. The user may be but not limited to a medical expert, a doctor, a nurse and a trained professional. For example, a medical expert may suggest few health parameters based on a medical analysis performed on a patient. The medical expert may alter a clinical category if one or more suggested health parameters are not present in the multiple clinical categories. Then a clinical category may be altered by adding health parameters that may be missing or replacing some health parameters in the clinical category with few suggested health parameters. In this case, the replaced health parameters may not necessarily be monitored according to the medical expert. In an embodiment, the clinical category may be altered by changing a threshold parameter value associated with a health parameter in the clinical category. A history of alterations made to the multiple clinical categories may be stored in the memory 104.

In another embodiment, the processor(s) 102 may be able to define a new clinical category and associated health parameters based on the user input. The defined clinical category may be stored in the memory 104. The processor(s) 102 may also determine parameter values related to the monitored health parameters. These parameter values may be presented in the form of health profiles. Health profiles associated with all the patients may be presented through a user interface (not shown in FIG. 1) connected to the system 100. Further the user interface may indicate the clinical category associated with each patient. The health profile and the clinical categories of the patients enable the medical expert to monitor the health condition of each patient in real time. Thus any changes in the health condition of patient may be conveniently monitored to take appropriate actions.

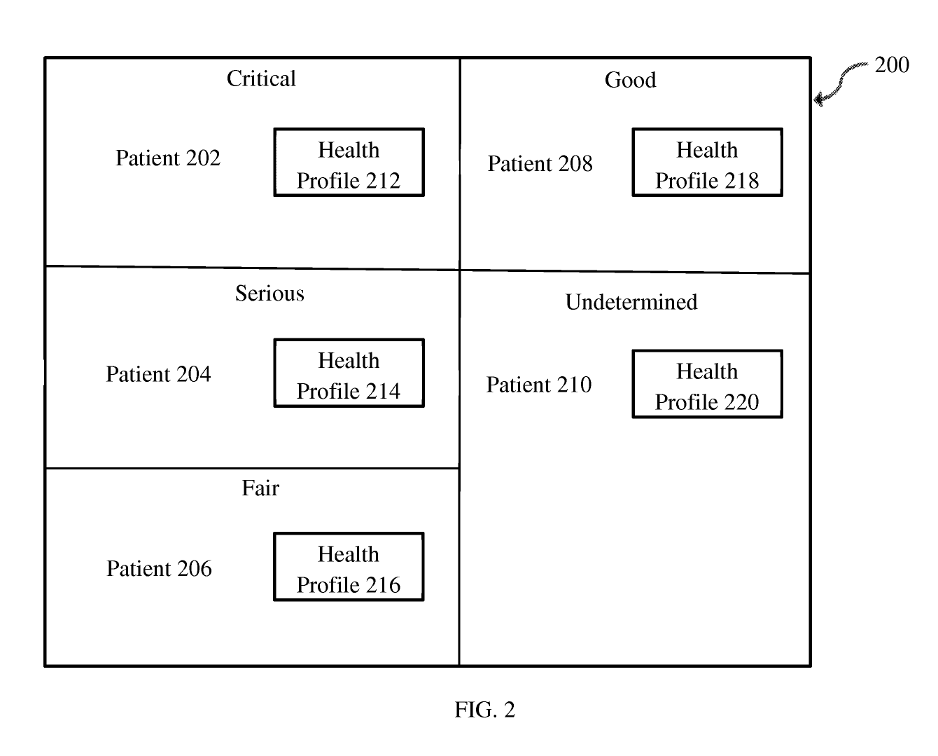

Turning now to FIG. 2, FIG. 2 is a schematic illustration of a user interface 200 presenting health profiles of patients in accordance with an embodiment. The user interface 200 presents clinical categories of the patients such as, a patient 202, a patient 204, a patient 206, a patient 208 and a patient 210. As illustrated the clinical categories include critical, serious, fair, good and undetermined associated with the patient 202, the patient 204, the patient 206, the patient 208 and the patient 210 respectively. The clinical categories may be arranged in separate regions in the user interface 200. Each clinical category may differ from another clinical category in terms of health parameters monitored and threshold parameter values associated with their health parameters explained in conjunction with FIG. 1. For example considering a critical category and a serious category there may be a difference in the health parameters monitored in each of these categories and corresponding threshold parameter values. More specifically few health parameters such as, temperature present in the critical category may be omitted in the serious category and also few threshold parameter values of health parameters such as, heart rate and pulse rate may have a higher threshold parameter value as compared to threshold parameter values of heart rate and pulse rate associated with the serious category.

The health parameters monitored for each patient may be presented in the user interface 200 in the form of health profiles. The user interface 200 illustrates the health profiles such as, a health profile 212, a health profile 214, a health profile 216, a health profile 218 and a health profile 220 of the patient 202, the patient 204, the patient 206, the patient 208 and the patient 210 respectively. A health profile of a patient may present parameter values of various monitored health parameters. In an embodiment, the health profile may indicate variation in parameter values in a graphical form. Further, in an embodiment the health profile may include parameter values associated with the health parameters. The patients and their health profiles may be presented in the user interface 200 in a predefined configuration based on a clinical category of each patient. For instance the patients and their health profiles may be arranged based on a criticality associated with the clinical category of each patient. Thus, as illustrated in the embodiment depicted in FIG. 2, the patient 202 and their health profile 212 may be presented first as the patient 202 belongs to the clinical category such as, critical. Similarly, the patient 204, the patient 206, the patient 208 and the patient 210 and their associated health profiles such as the health profile 214, the health profile 216, the health profile 218 and the health profile 220 are presented after the patient 202 in an order of criticality associated with their clinical categories. However, the patients and their health profiles may be presented in any other manner or order without deviating from the scope of this invention.

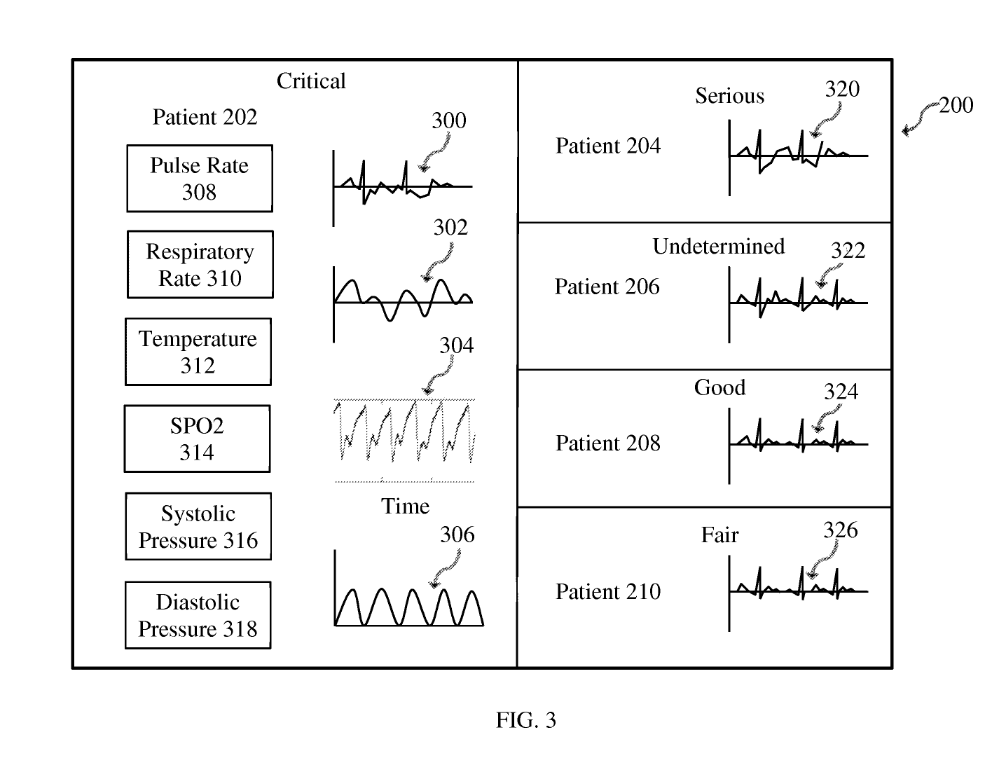

In an embodiment, a health profile associated with each patient may present only few health parameters and associated parameter values in the user interface 200. In case the user wants to view parameter values of all health parameters associated with a patient, then the user may need to select the patient. FIG. 3 is a schematic illustration of the user interface 200 presenting various health parameters associated with the patient 202 present in the critical clinical category in accordance with an embodiment. In an embodiment, when the user selects the patient 202 shown in FIG. 1, then the region for the patient 202 may present all the health parameters monitored for the patient 202. The health parameters may be presented when the region expands or scrolls down. The presented health parameters are part of the health profile 212. In an embodiment, the user interface 200 may present health parameters desired by the user based on user inputs. The user may be provided an option to input desired health parameters and accordingly the region for the patient 202 may expand to show these desired health parameters. The user can select or click on the same region of the patient 202 to contract so that all the health parameters are not displayed. Once the region contracts the user interface 200 may display only few health parameters of the patient 202. For instance, once the region contracts a variation in heart rate of the patient 202 may be displayed in the user interface 200. In another way, the user interface 200 may display a variation in parameter value associated with an important health parameter that indicates a health condition of the patient 202. Further, the user interface 200 may provide different techniques for expanding and contracting the region of each patient to view the various health parameters and their parameter values.

The health parameters displayed may include but are not limited to pulse rate, respiratory rate, temperature, SPO₂, systolic pressure and diastolic pressure. The health parameters may be displayed in the form of graphs and parameter values. The health parameters displayed in the form of graphs include a heart rate graph 300, a respiratory rate graph 302, a SPO₂ graph 304, and a systolic and diastolic pressure graph 306. These graphs may indicate the variation in the parameter values associated with the health parameters in terms of time. The graphs displayed may be similar to graphs already known in the art. These graphs provide a history of variation in parameter values associated with the health parameters accessible to the user. The parameter values displayed may include a pulse rate 308, a respiratory rate 310, a temperature 312, a SPO₂ 314, a systolic pressure rate 316, and a diastolic pressure rate 318. These parameter values may indicate values with respect to the health parameters at a particular instant of time. The parameter values may be obtained in real time from multiple medical devices connected to the patient's body. The user, for example, a nurse may view all the health parameters and their parameter values for closely monitoring the patient 202 if the patient 202 is found in a too critical condition. Further, the user interface 200 may also present a heart rate graph 320, a heart rate graph 322, a heart rate graph 324 and a heart rate graph 326 for the patient 204, the patient 206, the patient 208 and the patient 210 respectively. The nurse may view all the health profiles of the patients through the user interface 200 and provide proper medication to the patients to stabilize the patient's condition.

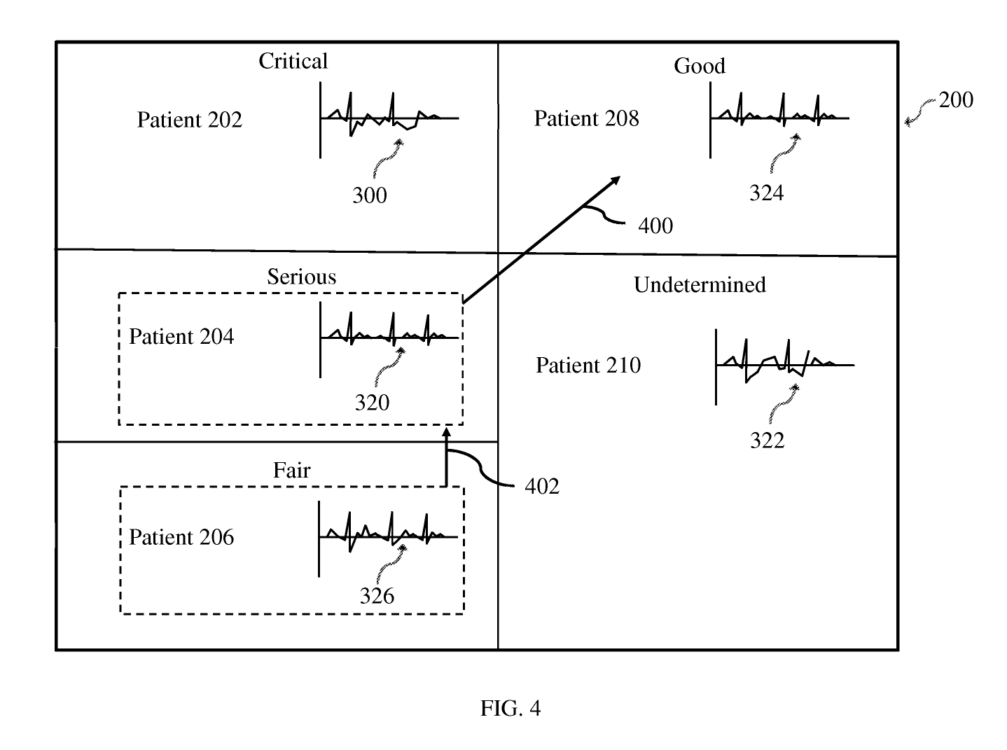

Due to medication and other factors the health condition of the patients may vary. The system 100 may analyze the health parameters and the parameter values associated with each patient and move the patient from one clinical category to another clinical category. FIG. 4 is a schematic illustration of the user interface 200 displaying the patients shifting between multiple clinical categories in accordance with an embodiment. As illustrated in FIG. 4 the patient 202, the patient 204, the patient 206 and the patient 208 are classified in the clinical categories such as, the critical category, the serious category, the fair category, the good category and the undetermined category respectively. These patients are continuously monitored and a change in health condition may be identified in the patient 204 present in the serious category. The health condition of the patient 204 may have improved and hence the medical expert may decide to stop monitoring some of the health parameters or threshold parameter values of few health parameters need to be changed. In this case, the medical expert or the user may move the patient from the serious category to the good category considering the health condition of the patient 204 is stable or improved, indicated by an arrow line 400.

In another embodiment the system 100 may identify the health parameter values associated with the patient 204 as below their threshold parameter values and stable for a considerable period of time for example, a threshold time period. The processor(s) 104 may then automatically move the patient 204 from a current clinical category to another clinical category of the multiple clinical categories. For example the patient 204 may be shifted from the serious category to the good category. The good category and associated health parameters may be selected from the multiple clinical categories. All such history of movements of a patient from a clinical category to another clinical category may be stored in the memory 104. Once the patient 204 shifts to the good category some of the pre-stored health parameters may not be monitored and threshold parameter values of some health parameters to be monitored may need change. The changes in the health parameters and the threshold parameter values may be performed manually by the user. In an embodiment, the changes in the health parameters and the threshold parameter values may be performed automatically by the processors(s) 102. As the patient 204 is present in the good category, the nurse or the medical expert may give less attention to the patient 204.

Similarly health condition of a patient may shift to serious after remaining in a stable condition for long time. To this end, as an embodiment illustrated in FIG. 4, the patient 206 may move from a fair category to the serious category indicated by an arrow line 402. This change in clinical category may be due to worsening of health condition of the patient 206. The system 100 may have determined a change in parameter values associated with the patient 206 or undesirable fluctuation in parameter values associated with various health parameters in order to make a change in the clinical category. For example, there may be fluctuation in a parameter value of heart rate above a threshold parameter value for a considerable period of time. This fluctuation may indicate that there is a possibility of a heart failure. Further it may be identified that the parameter value is fluctuating above the threshold parameter value associated with the serious category. As a result the patient 206 may be shifted from the fair category to the serious category.

When the clinical category of the patient 206 is changed then various health parameters associated with the serious category may need to be monitored for the patient 206. The serious category may have additional health parameters and higher threshold parameter values as compared to the fair category. Thus the patient 206 may be monitored on the health parameters related to the serious category. Also the nurse or the medical expert taking care of the patient may give more attention while monitoring the patient 206 and other patients present in the critical category. As the system 100 classifies the patients in the multiple clinical categories the patients having a serious health condition can be provided more attention by the nurse or the medical expert. Also the user interface 200 indicates a criticality associated with the patient that helps the nurse or the patient in identifying critically ill patients in a convenient manner and provides proper medication. Increased attention and proper medication may enable the patient to shift to a desired health condition such as, a good or fair health condition. Hence a comparison between a current health condition and a desired health condition may help the nurse or the medical expert to analyze the deviation in health condition of the patient from the desired health condition.

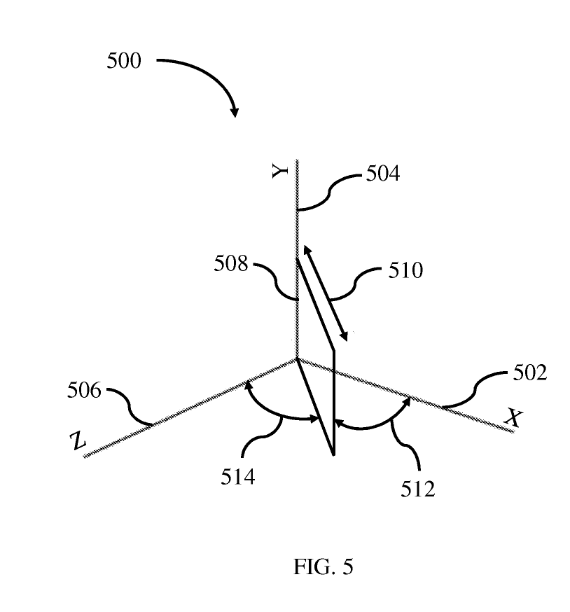

FIG. 5 is a schematic illustration of a user interface element 500 depicting comparison of a current health condition of a patient with a previous health condition and a desired health condition of the patient in accordance with an embodiment. The user interface element 500 may be a three dimensional coordinate system having an X-coordinate 502, a Y-coordinate 504 and a Z-coordinate 506. The X-coordinate 502, the Y-coordinate 504 and the Z-coordinate 506 may be associated with the current health condition, the desired health condition and the previous health condition of the patient respectively. However, the user interface element 500 may be depicted in any other manner to indicate the comparison between various health conditions of the patient. The user interface element 500 may be presented in the user interface 200. In the user interface element 500 the comparison of the current health condition of the patient with the previous health condition and the desired health condition of the patient may be depicted in the form of a degree of deviation. An amount of degree of deviation may be represented in the form of an area 508. The deviation of the current health condition from the desired health condition and the previous health condition is indicated by an arrow 510, an arrow 512 and an arrow 514. For example, in order to determine a deviation in the current health condition a waveform of current heart rate is compared with a desired waveform and a previous waveform. Based on this comparison an amount of closeness or deviation in the present health condition is determined. The amount of closeness or deviation of the present health condition is indicated by the area 508. Thus, the area 508 shown by the user interface element 500 may enable the nurse or the medical expert to determine the effort required in order to reach the desired health condition for the patient. Based on the degree of deviation of the health condition, the patient may be classified in a clinical category of the multiple clinical categories. Moreover, the degree of deviation may also enable the nurse or the medical expert to decide on the treatment that can be provided to shift the patient to the desired health condition.

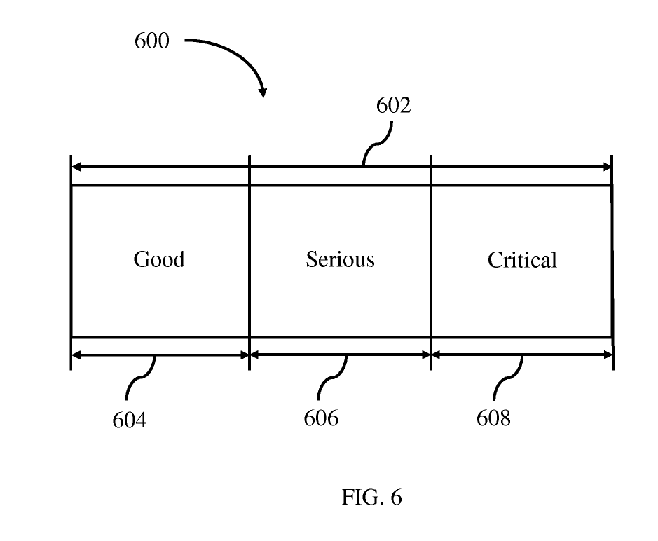

Referring now to the embodiment depicted in FIG. 6, FIG. 6 is a schematic illustration of a user interface element 600 depicting a variation of health condition of a patient in accordance with an embodiment. The variation of health condition of the patient may be stored as a history in the memory 104. The user interface element 600 may be presented in the user interface 200. The user interface element 600 may indicate variations in health condition of a patient occurred during a period when the patient may have a deviation from normal health condition and under medical treatment. As illustrated in FIG. 5, the patient's health condition changes to classify the patient in three different clinical categories such as good, serious and critical. However, the patient's health condition may vary between more or less than three clinical categories shown in FIG. 5. Further, the user interface element 600 may be depicted in any other manner to illustrate the variation in the health condition of the patient. During the whole duration when the patient is not having a normal health condition the clinical category of the patient varies between these three different clinical categories. For example, the whole duration for which the patient is under treatment may be considered as 100% in terms of time indicated by arrow 602. Then the duration for which the patient may be in the clinical categories good, serious and critical may be represented as 50%, 30% and 20% respectively indicated by an arrow 604, an arrow 606 and an arrow 608. Thus the user interface element 600 indicates that patient have fluctuation in health condition but have been in a good clinical category or a stable health condition for half of the time duration. This may indicate that patient is more stable and requires some medication to regain the normal health condition.

In an embodiment, the user interface element 600 may also indicate a stage when the patient is in three different clinical categories. For example, the user interface element 600 may indicate that the patient is in critical and serious clinical category at the initial stages. Thereafter the patient moved to the good category and remained in this clinical category for rest of 50% of the duration. Thus, the user interface element 600 may provide an indication that the patient has improved from the critical health condition to a more stable condition and is remaining stable for considerable amount of time. Further the user interface element 600 may also present fluctuations in health conditions of the patient and also frequency of these fluctuations. Such information enables the nurse or the medical expert treating the patient to give more attention and proper medication as compared to other patients who are in the stable condition.

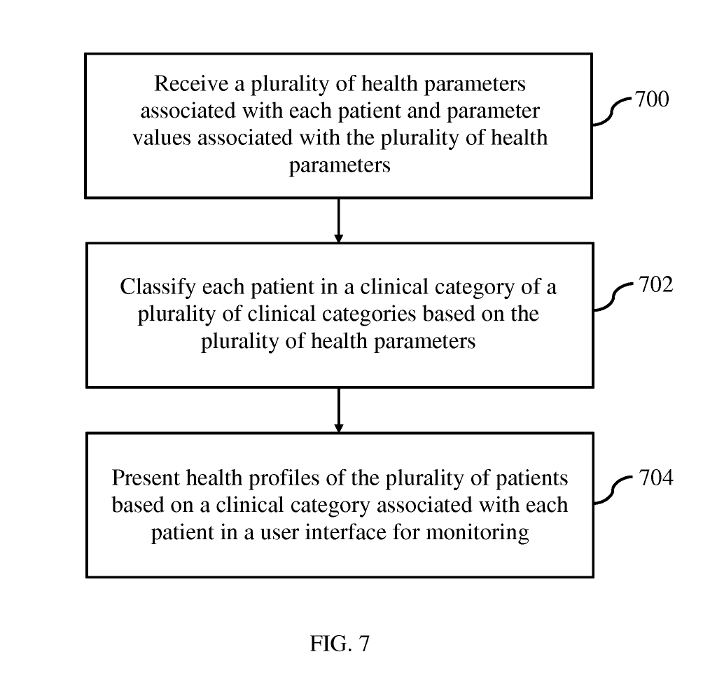

Turning now to FIG. 7, FIG. 7 illustrates a flow diagram of a method for monitoring multiple patients in accordance with an embodiment. The health condition of the multiple patients may be continuously monitored using various medical devices connected to the patient's body. The patients may be monitored using these medical devices for analyzing their health condition once a nurse or a patient examines the patients. To analyze the health condition of each patient, multiple health parameters may be monitored and corresponding parameter values may also be determined. The multiple health parameters and the parameter values associated with these health parameters may be received at step 700. For example the system 100 may receive health parameters monitored for a patient and corresponding parameter values as input from a user such as, a nurse or a medical expert or an experienced professional. In another scenario the health parameters and the parameter values may be directly received by at the system 100 through the medical devices connected to the patient. In this scenario, the nurse or the patient may not need to perform manual input of the parameter values and the health parameters.

Based on the health parameters and the parameter values received, each patient is classified in a clinical category of multiple clinical categories. The clinical categories may include but are not limited to critical, serious, fair, good and undetermined. A clinical category indicates a criticality level associated with a health condition of the patient. Each clinical category may be associated with a set of health parameters. In an embodiment, each health parameter associated with a clinical category may have a threshold parameter value. The different types of clinical categories are explained in detail in conjunction with FIG. 1.

In order to determine an appropriate clinical category to be assigned to the patient, it is determined whether the set of health parameters associated with each clinical category matches with health parameters received. Moreover a parameter value associated with a received health parameter may also be compared with the threshold parameter value to determine the appropriate clinical category. The comparison of the parameter value may involve identifying whether the parameter value associated with a health parameter is greater than a threshold parameter value. For example, if the monitored parameter value is above a threshold parameter value then the patient may be classified in a clinical category that is related to the threshold parameter value.

Once all the patients are classified in their respective clinical categories, the medical devices may be used to monitor various health parameters of the patients based on their clinical categories. Then the parameter values associated with these health parameters may be determined. Subsequently health profiles of the multiple patients may be presented based on clinical category associated with each patient at step 702 in a user interface such as the user interface 200. A health profile of a patient may indicate parameter values of various monitored health parameters. In an embodiment, the health profile may indicate the parameter values in a graphical form. The health profiles of the patients are explained in detail in conjunction with FIG. 2. The multiple patients and their health profiles are arranged in a predefined configuration based on a clinical category associated with each patient. For instance, the patients and their health profiles may be arranged based on a criticality associated with the clinical category of each patient. Explaining with reference to FIG. 2, the patient 202 and their health profile 212 may be presented first as the patient 202 belong to the clinical category such as, critical. Similarly, the patient 204, the patient 206, the patient 208 and the patient 210 and their associated health profiles such as the health profile 214, the health profile 216, the health profile 218 and the health profile 220 are presented in an order of criticality associated with their clinical categories.

The health parameters and the parameter values associated with each patient may be then analyzed and move the patient from the current clinical category to another clinical category of the multiple clinical categories. The patient may be moved from the current clinical category based on a variation in one or more health parameters of the patient and one or more parameter values associated with the health parameters. For example a patient may move from a serious clinical category to a good clinical category considering the health condition of the patient is stable or improved. In this scenario, the health condition may have varied due to a change in the parameter values associated with multiple health parameters monitored for the patient. The parameter values may have moved below corresponding threshold parameter values associated with the serious clinical category. Further, these parameter values may be such that the patient can be categorized in the good clinical category. Consequently the patient is classified in the good clinical category. Due to increased attention and proper medication the patient have shifted to a desired clinical category such as, a good or fair clinical category. Thus an analysis of deviation of a current health condition of the patient with respect to a desired health condition may help the nurse or the medical expert.

To this end a degree of deviation between the desired clinical category associated with each patient with respect to the current clinical category and the previous clinical category may be analyzed and presented to the user such as the nurse or the medical expert in the user interface such as the user interface 200. The mode of presenting this degree of deviation in health condition of patient in accordance with an embodiment in explained in detail in conjunction with FIG. 5. The degree of deviation in the health condition may enable the nurse or the medical expert to provide proper attention and medication to the patient experiencing a critical health condition.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for monitoring a plurality of patients, the system comprising:
at least one processor configured to:
receive a plurality of health parameters associated with each patient and parameter values associated with the plurality of health parameters;
classify each patient in a clinical category of a plurality of clinical categories based on the plurality of health parameters, wherein each clinical category indicates a criticality level associated with a health condition of a patient; and
present health profiles of the plurality of patients based on the clinical category associated with each patient in a user interface for monitoring each patient, wherein the health profiles indicate the parameter values associated with the plurality of health parameters.

2. The system of claim 1, wherein the at least one processor is further configured to define the plurality of clinical categories, wherein each clinical category is associated with at least one health parameter of a set of health parameters and a threshold parameter value associated with each health parameter of the set of health parameters.

3. The system of claim 2 further comprising at least one memory configured to store the plurality of clinical categories and the set of health parameters associated with each clinical category.

4. The system of claim 2, wherein the plurality of clinical categories is defined based on user input.

5. The system of claim 2, wherein the plurality of clinical categories is predefined.

6. The system of claim 2, wherein the at least one processor is further configured to classify each patient by at least one of:
determine whether the plurality of health parameters of each patient is similar to a set of health parameters associated with a clinical state; and
identify whether a parameter value associated with a health parameter of each patient is greater than a threshold parameter value associated with a corresponding health parameter of a clinical state.

7. The system of claim 1, wherein the at least one processor is further configured to present health profiles of the plurality of patients by arranging the plurality of patients and the health profiles in a predefined configuration based on a clinical category associated with each patient, wherein the predefined configuration is related to a criticality level associated with each clinical category.

8. The system of claim 1, wherein the at least one processor is further configured to change a patient from a current clinical category to another clinical category of the plurality of clinical categories based on a variation in at least one health parameter of the patient and at least one parameter value of the at least one health parameter.

9. The system of claim 8, wherein the at least one processor is further configured to:
analyze a degree of deviation of a desired clinical category associated with each patient with respect to the current clinical category and a previous clinical category associated with each patient; and
present the degree of deviation in the user interface.

10. A method for monitoring a plurality of patients, the method comprising:
receiving a plurality of health parameters associated with each patient and parameter values associated with the plurality of health parameters;
classifying each patient in a clinical category of a plurality of clinical categories based on the plurality of health parameters, wherein each clinical category indicates a criticality level associated with a health condition of a patient; and
presenting health profiles of the plurality of patients based on the clinical category associated with each patient in a user interface for monitoring, wherein the health profiles indicate the parameter values associated with the plurality of health parameters.

11. The method of claim 10, further comprising defining the plurality of clinical categories, wherein each clinical category is associated with at least one health parameter of a set of health parameters and a threshold parameter value associated with each health parameter of the set of health parameters.

12. The method of claim 11, wherein classifying each patient comprises at least one of:
determining whether the plurality of health parameters of each patient is similar to a set of health parameters associated with a clinical category; and
identifying whether a parameter value associated with a health parameter of each patient is greater than a threshold parameter value associated with corresponding health parameter of the clinical category.

13. The method of claim 10, wherein presenting health profiles of the plurality of patients comprises arranging the plurality of patients and the health profiles in a predefined configuration based on a clinical category associated with each patient, wherein the predefined configuration is related to a criticality level associated with each clinical category.

14. The method of claim 10 further comprising changing a patient from a current clinical category to another clinical category of the plurality of clinical categories based on a variation in at least one health parameter of the patient and at least one parameter value of the at least one health parameter.

15. The method of claim 14 further comprises:
analyzing a degree of deviation between a desired clinical category associated with each patient with respect to the current clinical category and a previous clinical category associated with each patient; and
presenting the degree of deviation in the user interface.
